(19) United States
(12) Patent Application Publication
(10) Pub. No.: US 2013/0334942 A1
(43) Pub. Date: Dec. 19, 2013

(54) HIGH-PRESSURE CLEANING APPLIANCE

(71) Applicant: Alfred Karcher GmbH & Co. KG, Winnenden (DE)

(72) Inventors: Harald Schestag, Sulzbach (DE); Ralph Seitter, Backnang (DE)

(73) Assignee: Alfred Karcher GmbH & Co. KG, Winnenden (DE)

(21) Appl. No.: 13/972,160

(22) Filed: Aug. 21, 2013

Related U.S. Application Data
(63) Continuation of application No. PCT/EP2011/053403, filed on Mar. 7, 2011.

(51) Int. Cl. A47L 11/40; B08B 3/00

(52) U.S. Cl. CPC A47L 11/40; B08B 3/00
USPC 312/236; 312/326

(57) ABSTRACT

A high-pressure cleaning appliance is provided including a housing which has a hood and a rear wall of the housing, the hood being pivotable from an open position in which the housing is open into a closed position in which the housing is closed, and wherein the high-pressure cleaning appliance comprises a locking device having at least one first locking element located on the hood and having at least one second locking element which couples with the first locking element in the closed position of the hood to lock the latter. The high-pressure cleaning appliance includes an aligning device having at least one first aligning element located on the hood and at least one second aligning element integrally formed on the rear wall of the housing and that couples with the at least one first aligning element for aligning the hood in relation to the rear wall of the housing.

### CROSS-REFERENCE TO RELATED APPLICATIONS

This application is a continuation of international application number PCT/EP2011/053403, filed on Mar. 7, 2011, which is incorporated herein by reference in its entirety and for all purposes.

### FIELD OF THE INVENTION

The present invention relates to a high-pressure cleaning appliance comprising a housing that has a hood and a rear wall of the housing, the hood being pivotable from an open position in which the housing is open into a closed position in which the housing is closed, and the high-pressure cleaning appliance comprising a locking device having at least one first locking element located on the hood and at least one second locking element that couples with the first locking element in the closed position of the hood in order to lock same.

### BACKGROUND OF THE INVENTION

With such a high-pressure cleaning appliance, the hood may be moved into the open position to make accessible a receiving space which is encompassed by the housing. For example, a motor pump unit with which cleaning fluid that can be dispensed by the high-pressure cleaning appliance can be put under pressure may be located in the receiving space. Furthermore, a heatable heat exchanger for heating the dispensable cleaning fluid may also be located in the receiving space. Access to the components of the high-pressure cleaning appliance located in the receiving space is necessary, for example, for maintenance of same. By pivoting the hood, it can be moved from the open position into the closed position by joining it to the rear wall of the housing, and in the closed position it can be locked by means of the locking device to prevent unintentional opening. The at least one first locking element, also referred to as the “hood lock,” is coupled to the at least one second locking element for this purpose. For example, the locking elements work together with one another by positive engagement.

An object underlying the present invention to improve upon a generic high-pressure cleaning appliance so that it can be handled more easily.

### SUMMARY OF THE INVENTION

In an aspect of the invention, a high-pressure cleaning appliance compries a housing that has a hood and a rear wall of the housing, the hood being pivotable from an open position in which the housing is open into a closed position in which the housing is closed. The high-pressure cleaning appliance comprises a locking device having at least one first locking element located on the hood and at least one second locking element that couples with the first locking element in the closed position of the hood in order to lock same. The high-pressure cleaning appliance comprises an aligning device having at least one first aligning element located on the hood and at least one second aligning element integrally formed on the rear wall of the housing and coupled to the at least one first aligning element for aligning the hood in relation to the rear wall of the housing such that the coupling of the at least one first aligning element and of the at least one second aligning element to one another in pivoting the hood from the open position to the closed position begins with traversal of a smaller pivot angle than the coupling of the at least one first locking element and of the at least one second locking element to one another.

### BRIEF DESCRIPTION OF THE DRAWING FIGURES

The foregoing summary and the following description may be better understood in conjunction with the drawing figures, of which:

FIG. 1 shows a perspective illustration of a high-pressure cleaning appliance in accordance with the invention comprising a housing which has a housing rear wall and a hood that is in a closed position;

FIG. 2 shows a side view of the high-pressure cleaning appliance from FIG. 1, the hood being in a slightly open position;

FIG. 3 shows a perspective illustration of the rear wall of the housing of the high-pressure cleaning appliance from FIG. 1;

FIG. 4 shows a top view of the rear wall of the housing of the high-pressure cleaning appliance from FIG. 1;

FIG. 5 shows a sectional view along the line 5-5 in FIG. 4, also showing the hood of the high-pressure cleaning appliance;

FIG. 6 shows a sectional view along the line 6-6 in FIG. 5;

FIG. 7 shows a partial rear view of the high-pressure cleaning appliance from FIG. 1 just before locking the hood onto the rear wall of the housing;

FIG. 8 shows a sectional view along the line 8-8 in FIG. 7; and

FIG. 9 shows another perspective illustration of the rear wall of the housing of the high-pressure cleaning appliance from FIG. 1, to which a sliding handle is connected.

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a high-pressure cleaning appliance comprising a housing that has a hood and a rear wall of the housing, the hood being pivotable from an open position in which the housing is open into a closed position in which the housing is closed, and the high-pressure cleaning appliance comprising a locking device having at least one first locking element located on the hood and at least one second locking element that couples with the first locking element in the closed position of the hood in order to lock same. The high-pressure cleaning appliance comprises an aligning device having at least one first aligning element located on the hood and at least one second aligning element integrally formed on the rear wall of the housing and coupled to the at least one first aligning element for aligning the hood in relation to the rear wall of the housing such that the coupling of the at least one first aligning element and of the at least one second aligning element to one another in pivoting the hood from the open position to the closed position begins with traversal of a smaller pivot angle than the coupling of the at least one first locking element and of the at least one second locking element to one another.

The high-pressure cleaning appliance in accordance with the invention has at least one first aligning element located on the hood and, achieving a simple structural design, at least one second aligning element which is integrally formed in one piece onto the rear wall of the housing. When the hood is pivoted from the open position into the closed position, the at least one first aligning element and the at least one second aligning element may be coupled to one another to facilitate the alignment of the hood in relation to the rear wall of the housing for the user and to join them together as intended. When the hood is pivoted, the at least one first aligning element and the at least one second aligning element are already coupled to one another before the at least one first locking element and the at least one second locking element are coupled to one another for locking the hood in the closed position. This is achieved by the fact that the at least one first aligning element is positioned on the hood and the at least one second aligning element is positioned on the rear wall of the housing such that pivoting of the hood by a smaller pivot angle than that required to couple the locking elements to one another is sufficient to bring the aligning elements into coupled engagement with one another. This makes it easier for a user to bring the hood into the correct position in relation to the rear wall of the housing in pivoting the hood and even before it is locked, thereby improving the ease of handling of the high-pressure cleaning appliance.

The at least one first aligning element and the at least one second aligning element are coupled together in particular by being engaged with one another. At the start of the coupling, the engagement may be loose in order to facilitate the joining of the at least one first aligning element and the at least one second aligning element and thus the joining of the hood and the rear wall of the housing to one another. With increased pivoting, the loose engagement may change to an in particular positive engagement.

It is advantageous if the rear wall of the housing is an integrally formed part. This facilitates an especially simple structural design of the high-pressure cleaning appliance.

It is advantageous if the at least one first aligning element is integrally formed on the hood to further facilitate the structural design of the high-pressure cleaning appliance.

The at least one first aligning element and the at least one second aligning element are preferably coupled to one another in the closed position of the hood. The hood therefore also remains correctly positioned in its closed position in relation to the rear wall of the housing.

The at least one first aligning element and the at least one second aligning element advantageously are in positively-locked engagement with one another in the closed position of the hood in order to ensure a clearly defined relative position of the hood and the rear wall of the housing.

Preferably at least one aligning element is in particular a wedge-shaped, peg-shaped or hook-shaped projection, and the aligning element that couples with it is in particular a receptacle shaped like a well or a blind hole, into which the projection engages. The aligning element which is configured as a projection may be located on the hood, for example, and the aligning element configured as a receptacle may be formed in the rear wall of the housing. Conversely, however, it is also possible that an aligning element configured as a projection is integrally formed on the rear wall of the housing and that the receptacle for the projection is located on the hood. It is even conceivable that both the hood and the rear wall of the housing have at least one aligning element each in the form of a projection and at least one aligning element each in the form of a receptacle.

It is advantageous if the projection is formed to taper in the direction of a free end in at least one direction in space. The projection may thus be inserted more easily with the free end guiding it into the receptacle associated with it, and may be brought into loose engagement with the receptacle while the hood is being transferred from the open position to the closed position. This facilitates aligning the hood in relation to the housing wall. The projection is advantageously formed to taper in two directions in space running transversely with respect to one another so that it can more easily be inserted into the receptacle and coupled to it. This projection may be, for example, in the form of a cone, a truncated cone, a pyramid, a truncated pyramid, a wedge or a prism or the like. The receptacle is preferably designed to correspond to the projection, which is especially preferably engaged with the receptacle in a positively-locking manner in the closed position of the hood.

The aligning device preferably has a plurality of first aligning elements and a plurality of second aligning elements which make it possible to align the hood in relation to the rear wall of the housing in an improved manner. For example, four first aligning elements are located on the hood and four second aligning elements are integrally formed on the rear wall of the housing.

It is advantageous if two second aligning elements are integrally formed on the rear wall of the housing, so that they are offset in the direction of the front side of the high-pressure cleaning appliance in relation to the rear side of the high-pressure cleaning appliance. The two aligning elements which may be, for example, hook-shaped projections on the rear wall of the housing, are preferably located on the left longitudinal side and/or on the right longitudinal side of the high-pressure cleaning appliance, based on the longitudinal direction of said high-pressure cleaning appliance. Due to the offset of the two aligning elements in the direction of the front side of the high-pressure cleaning appliance, first aligning elements located on the hood may be coupled to these two aligning elements at an early stage when the hood is pivoted from the front side into the closed position in the direction of the rear side. The offset of the two aligning elements in relation to the rear side, for example, amounts to approximately one-fifth to two-fifths of the length of the high-pressure cleaning appliance, preferably one-fourth to one-third of the length.

The two second aligning elements are advantageously located at the bottom end of the rear wall of the housing, i.e., on a lower area of the rear wall of the housing in a use position of the high-pressure cleaning appliance, this lower area being located on or near a chassis of the high-pressure cleaning appliance, for example, on which the rear wall of the housing is positioned. At the top, i.e., on a top side of the rear wall of the housing facing away from the chassis and offset from the rear side in the direction of the front side of the high-pressure cleaning appliance, second aligning elements may be dispensed with. This makes it easier for a user to achieve engagement in the receptacle space.

It is advantageous if the housing comprises a left housing side wall and a right housing side wall, and if the rear wall of the housing has rear housing sidewall portions and forms the left housing side wall and the right housing side wall each in parts thereof, the rear housing sidewall portions being connected to one another on the rear side of the high-pressure cleaning appliance by means of a back wall formed by the rear wall of the housing. The rear wall of the housing may therefore have an approximately U-shaped design and may reliably encompass the receptacle space on and near the rear side in a manner that forms a seal, for example. The two second aligning elements mentioned above, offset in the direction of the front side of the high-pressure cleaning appliance, are preferably integrally formed on the left housing wall portion and on the right housing wall portion, preferably at the front, in order to simplify the structural design of the rear wall of the housing.

At least one container receptacle for a container holding a cleaning chemical is preferably integrally formed on the rear wall of the housing. This makes it possible to eliminate a separate container receptacle and to thereby simplify the design of the high-pressure cleaning appliance. The container receptacle may be designed in the form of a well, and may include a bottom wall with an opening to receive a valve device.

It is advantageous if the at least one container receptacle is located between a rear side of the high-pressure cleaning appliance and a second aligning element integrally formed on the rear wall of the housing, based on the longitudinal direction of the high-pressure cleaning appliance. The second aligning element is preferably one of the two above-mentioned second aligning elements which are integrally formed on the rear wall of the housing and offset in the direction of the front side of the high-pressure cleaning appliance. The offset of the second aligning element in the direction of the front side makes it possible to provide room for the container receptacle, which is integrally formed on the rear wall of the housing, in the interspace between the second aligning element and the rear side.

At least one second aligning element is advantageously integrally formed on or substantially on a rear side of the high-pressure cleaning appliance on the rear wall of the housing. Even a hood extending up to or substantially up to the rear wall can thereby be aligned in relation to the rear wall of the housing even before being locked in the closed position. The at least one second aligning element is, for example, a well-shaped receptacle with which a wedge-shaped or peg-shaped projection on the housing can engage.

It is advantageous if second aligning elements of the rear wall of the housing, which are located in front of the at least one second aligning element that is integrally formed on or substantially on the rear side, couple with the first aligning elements of the hood associated with them, in traversing a smaller pivot angle of the hood during transfer thereof from the open position into the closed position than the at least one second aligning element with the at least one first aligning element of the hood associated with it. This makes it possible to align and guide the hood into the closed position, to a certain extent successively, in relation to the rear wall of the housing during transfer of the hood from the open position to the closed position. After traversing a first pivot angle, first the second aligning elements of the rear wall of the housing which are located in front of the at least one second aligning element that is integrally formed on or substantially on the rear side, couple together. These are, for example, the two above-mentioned second aligning elements which are integrally formed on the rear wall of the housing and are offset in the direction of the front side. The hood may thus be already aligned in relation to the rear wall of the housing. The alignment may be improved by the fact that further pivoting of the hood couples the at least one second aligning element integrally formed on or substantially on the rear side with the first aligning element of the hood associated with it. For example, with further pivoting of the hood, the at least one first locking element and the at least one second locking element are subsequently coupled to lock the hood in the closed position.

The at least one second aligning element integrally formed on or substantially on the rear side is preferably integrally formed at the top end of the rear wall of the housing to simplify coupling with the first aligning element on the hood associated with the second aligning element.

Two second aligning elements are preferably integrally formed on or substantially on the rear side on the rear wall of the housing. This makes it possible to align the hood even better in relation to the rear wall of the housing.

It is advantageous if at least one second aligning element is located to the side of the at least one second locking element, based on a transverse direction of the high-pressure cleaning appliance. The coupling of the at least one first and the at least one second locking element may thereby be ensured, and consequently the hood may be guided reliably into the closed position. In the present case, “to the side” includes the case that there is a distance between the at least one second aligning element and the at least one second locking element. For example, the at least one second aligning element is located at a distance of approximately one-fourth the width of the high-pressure cleaning appliance from at least one second locking element in the transverse direction of the high-pressure cleaning appliance.

The at least one second locking element is preferably integrally formed on the rear wall of the housing. This makes it possible to simplify the structural design of the high-pressure cleaning appliance. The at least one second locking element is advantageously integrally formed on or substantially on the rear side and at the top of the rear wall of the housing. For example, the at least one second locking element is a well-shaped or funnel-shaped receptacle for the at least one first locking element in the form of a peg-shaped or anchor-shaped projection.

It is advantageous if the high-pressure cleaning appliance has an accessory holder for tools and/or cleaning accessories, and if connecting elements by means of which the accessory holder can be connected to the rear wall of the housing are integrally formed on the rear wall of the housing, the accessory holder in particular being detachably connectable to the rear wall of the housing. For example, the accessory holder can be latched to the rear wall of the housing. The accessory holder is, for example, a hose drum for or having a high-pressure hose or an approximately pocket-shaped receiving part for tools. The connecting elements are preferably located on the rear side so that the accessory holder can be connected to a back wall of the rear wall of the housing. The back wall may have a recess in the direction of the front side of the high-pressure cleaning appliance such that the accessory holder is at least partially located in this recess in the connected state and thereby protrudes less far to the rear beyond the rear side of the high-pressure cleaning appliance.

A preferred embodiment of the high-pressure cleaning appliance in accordance with the invention includes a heatable heat exchanger for heating a cleaning fluid that can be dispensed by the high-pressure cleaning appliance. The cleaning effect can be increased by heating the cleaning fluid. The heat exchanger is located in particular in the receiving space and is protected by the housing.

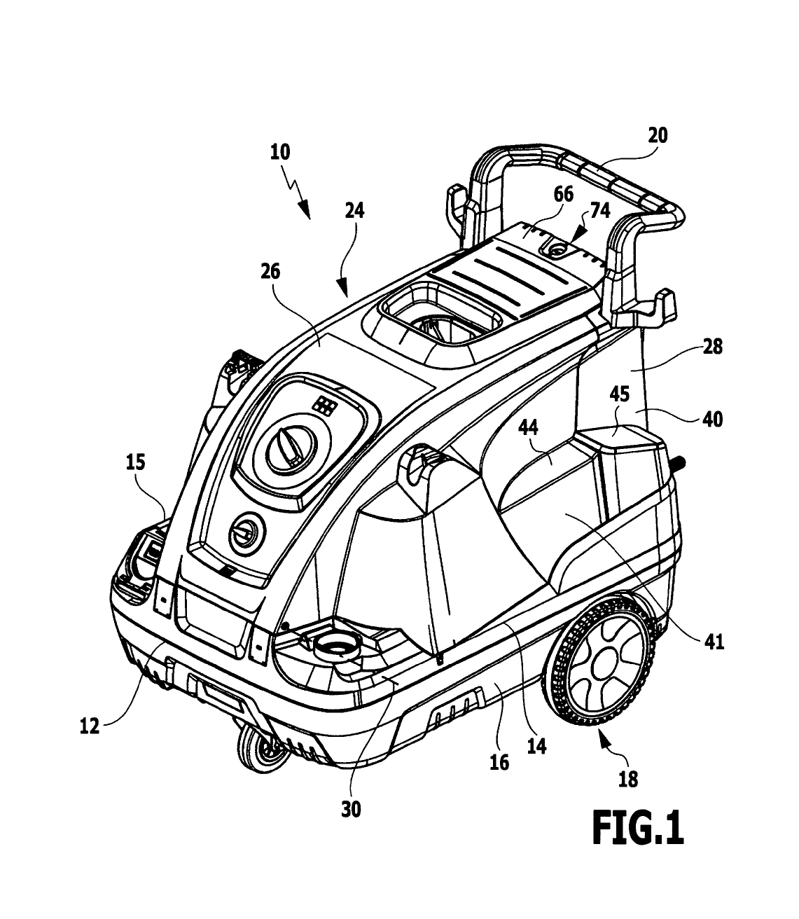

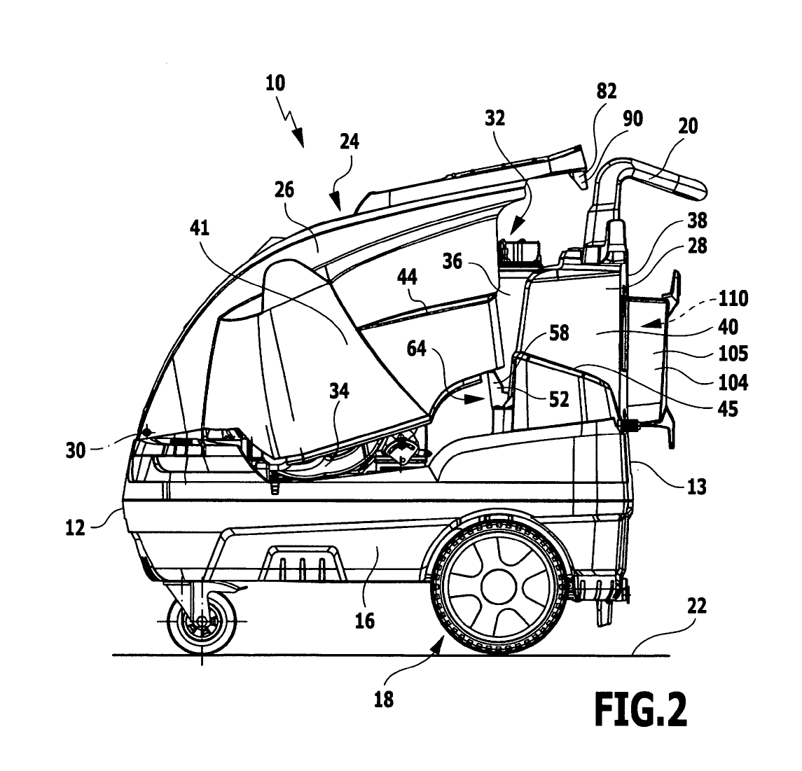

FIGS. 1 and 2 show a preferred embodiment of a high-pressure cleaning appliance in accordance with the invention, identified with reference numeral 10, in a perspective view and in a side view. The high-pressure cleaning appliance 10 has a front side 12, a rear side 13, a left side 14 and a right side 15. It includes a chassis 16 which holds running gear 18 at the bottom, as well as a bow handle 20 located on the rear side 13 to move the high-pressure cleaning appliance 10 by pushing or pulling it over a floor surface 22.

Position references such as “at the top,” “at the bottom” or the like in the present case refer to a use position of the high-pressure cleaning appliance 10 illustrated in FIGS. 1 and 2. The “front side” and the “rear side,” etc. refer to the longitudinal direction of the high-pressure cleaning appliance 10, which is also its main direction of movement.

Above the chassis 16, the high-pressure cleaning appliance 10 has a housing 24 which includes a hood 26 as well as a rear wall 28 of the housing that can be joined to the hood. The hood 26 is mounted on the front side 12 so it can be pivoted about a horizontal pivot axis 30 running transversely with respect to the longitudinal direction of the high-pressure cleaning appliance 10.

The hood 26 may assume a closed position as illustrated in FIG. 1, in which it is in contact with the rear wall 28 of the housing so that the housing 24 is closed. A receiving space 32 surrounded by the housing 24 and the chassis 16 is also closed in this case. Starting from the closed position, the hood 26 can be transferred into one or more open positions by pivoting it about the pivot axis 30 in the direction of the front side 12. In an open position of the hood 26, the housing 24 is open, and it is possible for a user to access the receiving space 32. FIG. 2 shows the hood 26 in an only slightly open position during transfer of the hood 26 to the closed position.

In FIG. 2, the slightly open hood 26 gives a view of a motor pump unit 34 of the high-pressure cleaning appliance 10 for increasing the pressure of the cleaning fluid that can be dispensed thereby. Furthermore, a heatable heat exchanger 36 with which the cleaning fluid can be heated to increase the cleaning effect is located in the receiving space 32.

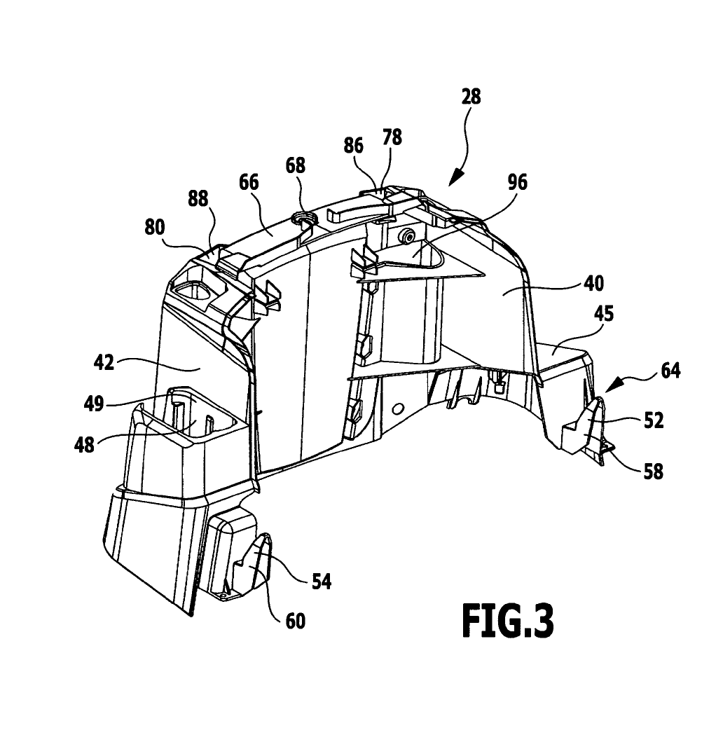

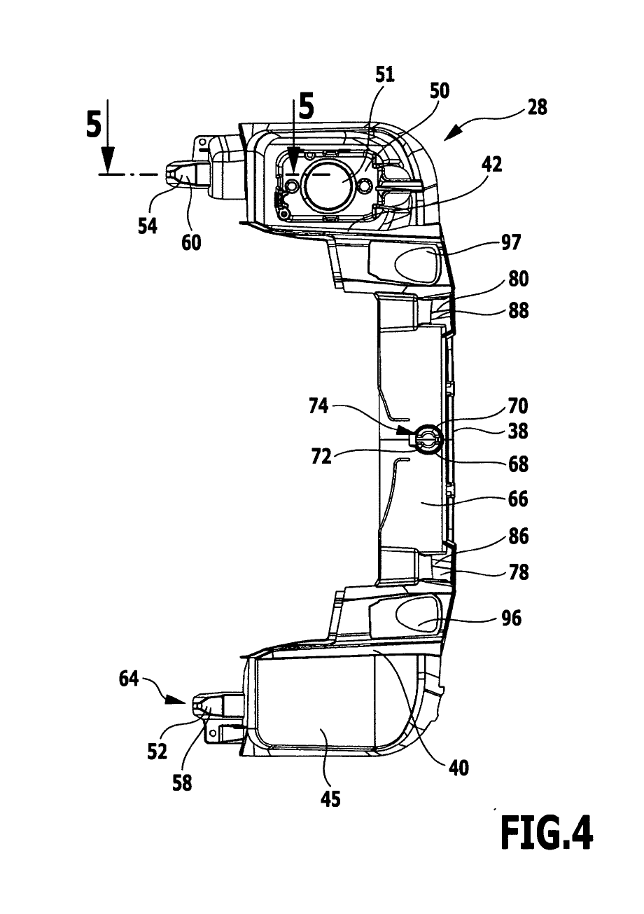

The rear wall 28 of the housing, shown in a perspective view and in a view from above in FIGS. 3 and 4, respectively, is an integrally formed part made of a plastics material in particular. As seen from above, it has an approximately U-shaped design, and is configured to be largely symmetrical with respect to a longitudinal central plane of the high-pressure cleaning appliance 10.

The rear wall 28 of the housing comprises a back wall 38 on the rear side 13, a left housing side wall portion 40 and a right housing side wall portion 42 which protrude on the left side 14 and the right side 15, respectively, at a right angle from the back wall 38 in the direction of the front side 12. The housing side wall portions 40 and 42 respectively form a left housing side wall 41 and a right housing side wall 43 in parts, the rest of these walls being formed by the hood 26.

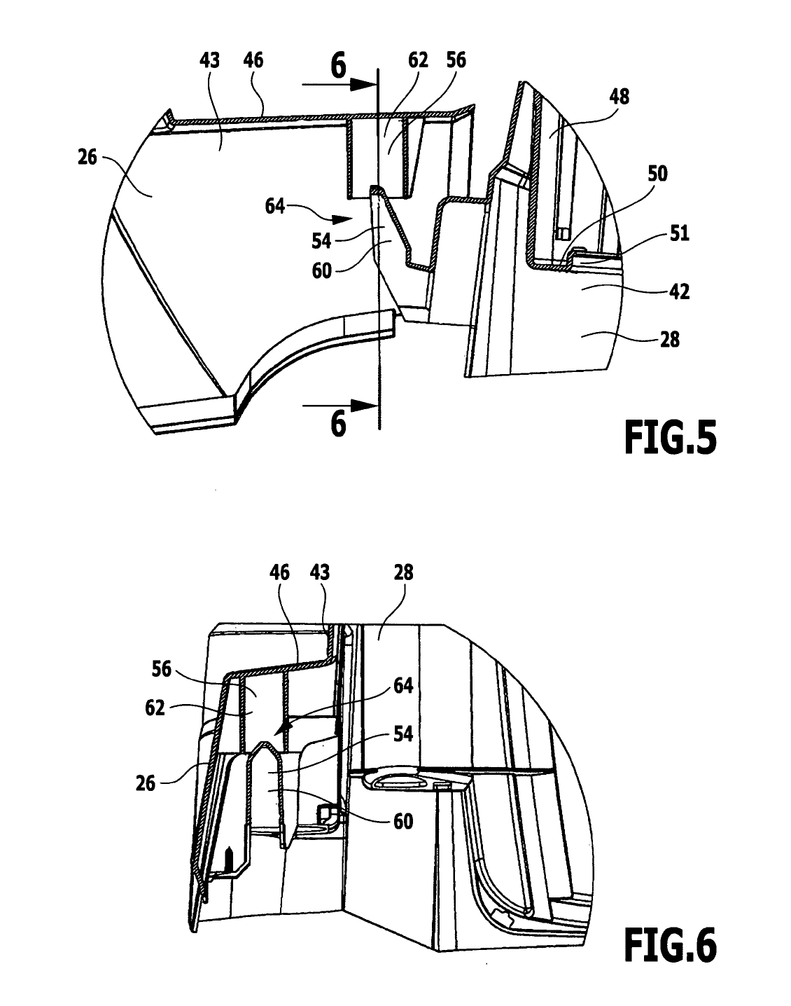

The housing side walls 41 and 43 run approximately from the center to the rear side 13 of the high-pressure cleaning appliance 10 in steps. To this end, the hood 26 has an approximately horizontal shoulder 44 on the left side 14, and on the left housing side wall portion 40, the rear wall 28 of the housing has a shoulder 45 that drops with a slight inclination with respect to the rear side 13. Similarly, the hood 26 has a shoulder 46 on the right side 15 (FIGS. 5 and 6).

On the right housing side wall portion 42 of the rear wall 28 of the housing, however, there is no shoulder corresponding to the shoulder 45, because in this area a container receptacle 48 is integrally formed on the rear wall 28 of the housing. The container receptacle 48 is configured in the form of a well, and has an insertion opening 49 at the top, as well as a bottom wall 50. An opening 51 into which a valve device (not shown in the drawing) can be inserted is formed in the bottom wall 50. A container (also not shown in the drawing) for a cleaning chemical may be inserted, upside down, into the container receptacle 48. Through the opening 51, the cleaning chemical can be pressurized, or mixed with cleaning fluid which is to be pressurized, in order to further increase the cleaning effect.

Hook-shaped projections 52 and 54 each extend away from the housing sidewall portions 40 and 42, respectively, in the direction of the front side 12 close to the chassis 16, and thus offset with respect to the rear side 13. The offset with respect to the rear side 13 is approximately one-fourth the length of the high-pressure cleaning appliance 10 in each case, and is somewhat larger in the case of the hook 54 because the container receptacle 48 is also integrally formed on the right side 15.

The projections 52 and 54 are configured to be symmetrical with respect to one another, and face in the direction of the hood 26, tapering in the direction of their free ends in two transversely oriented directions in space. Overall, the projections 52 and 54 have the approximate shape of truncated pyramids. Due to the rear wall 28 of the housing being formed in one piece, the projections 52 and 54 are with integrally formed thereon.

Receptacles integrally formed on the hood 26 are associated with the projections 52 and 54, with which they can couple. Of the receptacles, FIGS. 5 and 6 show only one receptacle 56, which is integrally formed on the shoulder 46 at the bottom and associated with the projection 54. A corresponding receptacle associated with the projection 52 has a design identical to that of the receptacle 56 and is integrally formed on the shoulder 44 at the bottom.

The receptacle 56 is configured in the form of a well having a rectangular cross section. If the hood 26 is transferred from an open position to the closed position, the projection 54 may engage in the receptacle 56 at its free end, thereby aligning the hood 26 in relation to the rear wall 28 of the housing, which is secured on the chassis 16, upon further closing, i.e., pivoting about the pivot axis 30. Since the projection 54 tapers in the direction of its free end, it first engages loosely in the receptacle 56 (FIGS. 5 and 6). While further closing the hood 26, a seating of the projection 54 in the receptacle 56 with positive engagement is achieved. If the hood 26 is in the closed position, the projection 54 and the receptacle 56 are in positive engagement with one another (not shown).

The situation is similar for the projection 52 and the receptacle associated with it (not shown in the drawing).

The projections 52 and 54, the receptacle 56 and the receptacle that is not shown here are aligning elements 58, 60 and 62 of an aligning device 64 of the high-pressure cleaning appliance 10. The aligning device 64, as explained above, serves to correctly align the hood 26 when it is moved into the closed position in relation to the rear wall 28 of the housing. This makes it easier to close the hood 26 and thereby improves the ease of handling the high-pressure cleaning appliance 10.

Aligning elements of the aligning device 64 located on the hood 26 are referred to as first aligning elements in the present patent application, and the aligning elements that are integrally formed on the rear wall 28 of the housing are referred to as second aligning elements.

An approximately horizontal upper wall portion 66 extends away from the back wall 38 at a right angle at the top of the rear side 13, in the direction of the front side 12. A passage 68 below which a funnel-shaped receptacle 70 is located is formed at the center of the upper wall portion 66. The receptacle 70 forms a locking element 72 in a locking device 74 which has another locking element 76 on the end of the hood 26 facing the rear side 13. The locking element 76 is configured in the fotin of a peg or an anchor, protruding downward from the hood 26, and is denoted as hood lock 77. In the closed position of the hood 26, the hood lock 77 may engage in a positively-locking manner in the receptacle 70 to lock the hood 26 to the rear wall 28 of the housing (not shown).

Two well-shaped receptacles 78 and 80 are integrally formed in the rear wall 28 of the housing on the rear side 13 at the side of the passage 68, each approximately at half the distance from the left side 14 and from the right side 15, these receptacles being configured to be symmetrical with respect to one another in relation to the central longitudinal plane of the high-pressure cleaning appliance 10. The cross section of the receptacles 78 and 80 decreases in the direction of the chassis 16.

Wedge-shaped projections 82 and 84 are associated with the receptacles 78 and 80, respectively, and are integrally formed on the end of the hood 26 facing the rear side 13 and protrude away from this end in the direction of the chassis 16. The projections 82 and 84 taper in the longitudinal direction of the high-pressure cleaning appliance 10.

The receptacles 78 and 80 as well as the projections 82 and 84 are also aligning elements 86 and 88 as well as 90 and 92, respectively, of the aligning device 64, and cooperate to align the hood 26 in relation to the rear wall 28 of the housing during closing. If the hood 26 is pivoted about the pivot axis 30, the projection 82 can engage in the receptacle 78 and couple with it. This is facilitated by the fact that the projection 82 tapers in the direction of its free end so that initially there is only a loose, non-positive engagement of the projection 82 in the receptacle 78. With further closing of the hood 26, the projection 82 engages deeper in the receptacle 78. When the hood 26 assumes the closed position, the projection 82 and the receptacle 78 are in positive engagement (not shown).

The hood 26 is therefore aligned by the projection 82 and the receptacle 78 in relation to the rear wall 28 of the housing during closing. This is accomplished by the initially loose engagement of the ultimately positive engagement in a reliable and user-friendly manner.

The situation is in a corresponding manner for the projection 84 and the receptacle 80, the coupling to be inserted being shown between the projection 84 and the receptacle 80 in FIG. 8.

With the high-pressure cleaning appliance 10, it is advantageous that the alignment of the hood 26 in relation to the rear wall 28 of the housing takes place successively during closing. Starting from the open position, the hood 26 may be pivoted about a first pivot angle until the coupling of the projection 54 with the receptacle 56 and the coupling of the projection 52 with the receptacle not shown here. This is due to the fact that the projections 52 and 54 are integrally formed on the rear wall 28 of the housing, so that they are offset far to the front from the rear side 13, for example, by approximately 30 cm. The projections 52 and 54 can engage in the receptacle 56 as well as in the receptacle that is not shown here, and define first points of alignment of the hood 26 in relation to the rear wall 28 of the housing. If the hood 26 is pivoted further in the direction of the closed position, the projections 52 and 54 engage progressively deeper in the receptacle 56 and in the receptacle that is not shown here, until the coupling of the projections 82 and 84 with the receptacles 78 and 80, respectively, begins after a further pivot angle is traversed. This defines second points of alignment of the hood 26 in relation to the rear wall 28 of the housing.

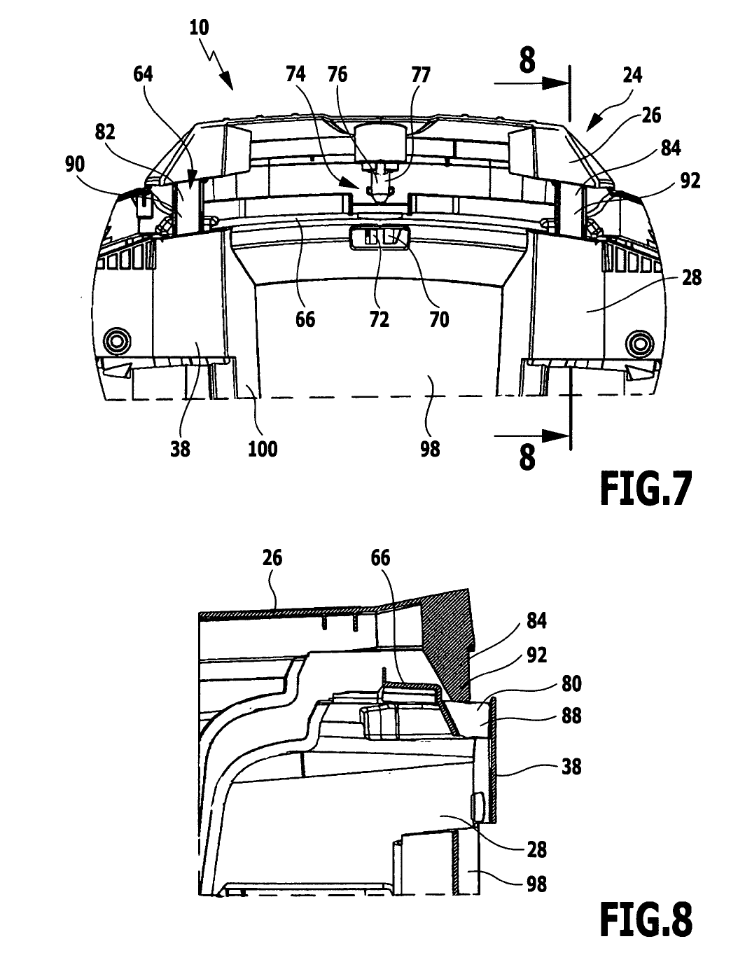

With further pivoting of the hood 26, the coupling of the projections 82 and 84 with the receptacles 78 and 80, respectively, is increased by the fact that they progressively engage further into one another. Only then does the hood lock 77 begin to engage in the receptacle 70 (FIG. 7). Since the receptacles 78 and 80 and the projections 82 and 84 are additionally located to the side of the hood lock 77 in the receptacle 70, the hood lock 77 is guided into the receptacle 70 in a targeted manner during closing of the hood 26. When the hood lock 77 engages in a positively-locking manner in the receptacle 70, the hood 26 is reliably locked to the rear wall 28 of the housing (not shown).

In summary, a user-friendly and reliable alignment of the hood 26 in relation to the rear wall 28 of the housing can be achieved by using the aligning device 64 when changing to the closed position.

For securing the rear wall 28 of the housing on the chassis 16, rods 94 and 95 are provided, these rods being connected to one another at the top end by means of the bow handle 20. The rods 94 and 95 may engage in a positively-locking manner in guides 96 and 97, respectively, which are integrally formed into the rear wall 28 of the housing and which may engage in a positively-locking manner in blind hole-like receptacles formed in the chassis 16 (not shown). The rods 94 and 95 may also be connected to the rear wall 28 of the housing from the rear side 13, for example by a screw connection.

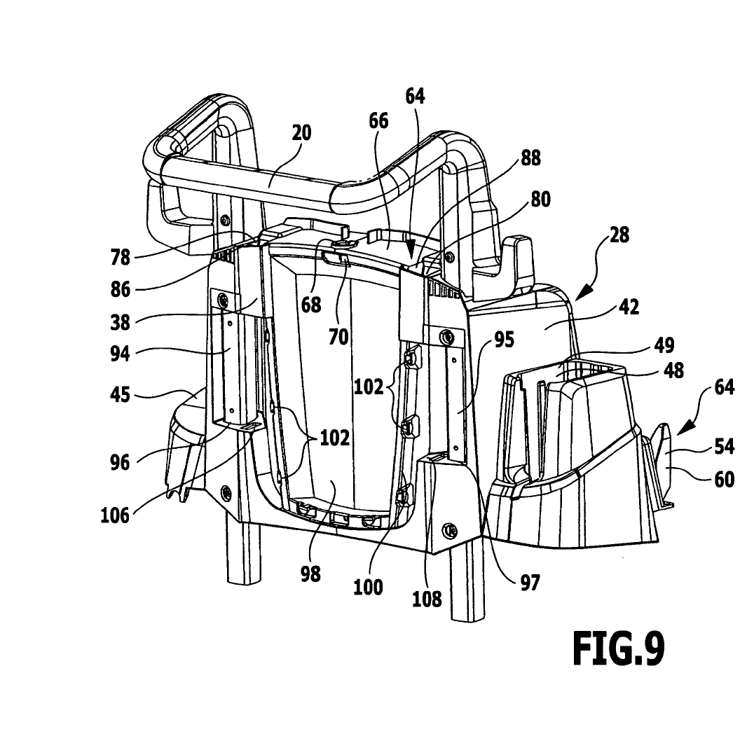

The back wall 38 is not planar as shown in FIG. 9 in particular, but instead is recessed to form a dish-shaped recess 98. The recess 98 extends from the upper wall portion 66 to the lower side of the rear wall 28 of the housing, and is bordered by an edge 100. A plurality of connecting elements 102 which may be in particular detent elements are provided on the edge 100 in a U-shaped arrangement. A total of nine connecting elements 102 are present.

To accommodate accessories, i.e., tools, for example, the high-pressure cleaning appliance 10 has a receptacle part 104 which is shown in a side view in FIG. 2. The receptacle part 104 is configured as a pocket-shaped accessory holder 105, although it lacks a side wall facing the rear wall 28 of the housing. The receptacle part 104 can be detachably fixed to the back wall 28 of the housing by latching by means of the connecting elements 102. The absent side wall of the receptacle part 104 is thus replaced by the back wall 38 in the region of the recess 98. In addition, the receptacle part 104 can be supported on shoulders 106 and 108 which are integrally formed into the rear wall 28 of the housing in the area of the guides 96 and 97, respectively. If the receptacle part 104 is attached to the rear wall 28 of the housing, a receiving space 110 for the accessories is formed between the rear wall of the housing and the receptacle part 104.

Instead of the receptacle part 104, a hose drum (not shown in the drawing) may also be detachably connected to the rear wall 28 of the housing, and in particular may be latched in place. The hose drum may likewise be supported on the shoulders 106 and 108, and may be latched to at least a portion of the connecting elements 102. This is sufficient for the load of the hose drum to be taken up by the rear wall 28 of the housing to the extent that the hose drum is held freely there. In addition, the hose drum may be secured by an additional connection, in particular a screw connection, on the rear wall 28 of the housing.

1. A high-pressure cleaning appliance, comprising a housing which has a hood and a rear wall of the housing, the hood being pivotable from an open position in which the housing is open into a closed position in which the housing is closed, and wherein the high-pressure cleaning appliance comprises a locking device having at least one first locking element located on the hood and having at least one second locking element which couples with the first locking element in the closed position of the hood to lock the latter, wherein the high-pressure cleaning appliance comprises an aligning device having at least one first aligning element located on the hood and having at least one second aligning element which is integrally formed on the rear wall of the housing and couples with the at least one first aligning element for aligning the hood in relation to the rear wall of the housing, whereby the coupling of the at least one first aligning element and the at least one second aligning element to one another in pivoting the hood from the open position into the closed position begins with traversal of a smaller pivot angle than the coupling of the at least one first locking element and the at least one second locking element to one another.

2. The high-pressure cleaning appliance in accordance with claim 1, wherein the rear wall of the housing is an integrally formed part.

3. The high-pressure cleaning appliance in accordance with claim 1, wherein the at least one first aligning element and the at least one second aligning element are coupled together in the closed position of the hood.

4. The high-pressure cleaning appliance in accordance with claim 3, wherein the at least one first aligning element and the at least one second aligning element are engaged with one another in a positively-locking manner in the closed position of the hood.

5. The high-pressure cleaning appliance in accordance with claim 1, wherein at least one first aligning element is a peg-shaped or hook-shaped projection, and that the aligning element coupling with it is a receptacle which is in the form of a well or a blind hole, into which the projection engages.

6. The high-pressure cleaning appliance in accordance with claim 5, wherein the projection is formed to taper in the direction of a free end in at least one direction in space.

7. The high-pressure cleaning appliance in accordance with claim 1, wherein the aligning device has a plurality of first aligning elements and a plurality of second aligning elements.

8. The high-pressure cleaning appliance in accordance with claim 1, wherein two second aligning elements are integrally formed on the rear wall of the housing, so that they are offset in relation to a rear side of the high-pressure cleaning appliance in the direction of a front side of the high-pressure cleaning appliance.

9. The high-pressure cleaning appliance in accordance with claim 8, wherein the two second aligning elements are located on the rear wall of the housing at a bottom end thereof.

10. The high-pressure cleaning appliance in accordance with claim 1, wherein the housing comprises a left housing side wall and a right housing side wall, and that the rear wall of the housing has rear housing sidewall portions and forms the left housing side wall and the right housing side wall each in parts thereof, the rear housing sidewall portions being connected to one another on the rear side of the high-pressure cleaning appliance by means of a back wall formed by the rear wall of the housing.

11. The high-pressure cleaning appliance in accordance with claim 1, wherein at least one container receptacle for a container containing a cleaning chemical is integrally formed on the rear wall of the housing.

12. The high-pressure cleaning appliance in accordance with claim 11, wherein the at least one container receptacle is located between a rear side of the high-pressure cleaning appliance and a second aligning element integrally formed on the rear wall of the housing, based on a longitudinal direction of the high-pressure cleaning appliance.

13. The high-pressure cleaning appliance in accordance with claim 1, wherein at least one second aligning element is integrally formed on or substantially on a rear side of the high-pressure cleaning appliance on the rear wall of the housing.

14. The high-pressure cleaning appliance in accordance with claim 13, wherein second aligning elements of the rear wall of the housing, which are located in front of the at least one second aligning element that is integrally formed on or substantially on the rear side, based on a longitudinal direction of the high-pressure cleaning appliance, are coupled with the first aligning elements of the hood which are associated with them in traversing a smaller pivot angle of the hood during transfer thereof from the open position into the closed position than the at least one second aligning element with the at least one first aligning element of the hood associated with it.

15. The high-pressure cleaning appliance in accordance with claim 13, wherein the at least one second aligning element integrally formed on or substantially on the rear side is integrally formed on the rear wall of the housing at the top end thereof.

16. The high-pressure cleaning appliance in accordance with claim 13, wherein two second aligning elements are integrally formed on the rear wall of the housing on or substantially on the rear side.

17. The high-pressure cleaning appliance in accordance with claim 1, wherein at least one second aligning element is located to the side of the at least one second locking element, based on the transverse direction of the high-pressure cleaning appliance.

18. The high-pressure cleaning appliance in accordance with claim 1, wherein the at least one second locking element is integrally formed on the rear wall of the housing.

19. The high-pressure cleaning appliance in accordance with claim 1, wherein the high-pressure cleaning appliance comprises a heatable heat exchanger for heating a cleaning fluid that can be dispensed by the high-pressure cleaning appliance.
